(19) United States
(12) Patent Application Publication
(10) Pub. No.: US 2004/0081035 A1
(43) Pub. Date: Apr. 29, 2004

(54) Rotary tray apparatus and method for determining identification number in rotary tray apparatus

(75) Inventor: Yoshikazu Fujishima, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 10/698,381

(22) Filed: Nov. 3, 2003

(30) Foreign Application Priority Data
Nov. 6, 2002 (JP) U2002-007032

(51) Int. Cl. G11B 7/085

(52) U.S. Cl. 369/30.36

(57) ABSTRACT

A rotary tray apparatus includes a counter for counting L levels and H levels of a pulse signal in one cycle at a predetermined time interval, a detecting unit for detecting whether or not a signal of an opposite level is input during counting of respective levels executed by the counter, a memory for storing previously-input counted numbers of respective pulse signals as reference values, and a controlling unit for comparing a counted value at this input time point with the reference values in the memory when an opposite level detecting signal is sent out from the detecting unit 10a during counting, then deciding that a noise signal is input when the counted value is out of tolerances of the reference values, and then initializing the counted values and continuing determination of the identification numbers based on the input pulse signal.

### BACKGROUND OF THE INVENTION

1. Field of the Invention

The present invention relates to a rotary tray apparatus for loading a plurality of sheets of disks such as CD for reproducing information recorded therein, and more particularly, a rotary tray apparatus capable of continuing to sense a disk position without hindrance even when a noise is superposed on a pulse signal in which used to sense the disk position. The present invention is also related to a method used in such rotary tray apparatus.

2. Description of the Related Art

Conventionally, there is known device in which detects a cycle of a pulse signal for not invalidating data even when a noise is superposed on the pulse signal (See JP-A-10-038907).

The device disclosed in JP-A-10-038907 includes an edge detecting unit, a timer, a level detecting unit, a level determining unit, a duty-ratio determining unit, and a restricting unit.

In the device, a level of the pulse signal is determined by the level determining unit every time when an edge detecting signal is output from the edge detecting unit. In a case where determined that the level is correct, a duty ratio of the pulse signal is determined by the duty-ratio determining unit.

In a case where determined by the level determining unit that the level is incorrect or determined by the duty-ratio determining unit that the duty ratio is incorrect, it is decided that the edge detected by the edge detecting unit is not the edge of the pulse signal. Thus, detecting of the pulse signal cycle is restricted by the restricting unit.

As a result, an erroneous detection of the pulse signal cycle is prevented in the device described above.

In the device disclosed in JP-A-10-038907, the level of the pulse signal and the duty ratio of the pulse signal are determined. However, the device does not have such a configuration to determine the level and the duty ratio of the pulse signal on the basis of the preceding input pulse signal or on the basis of the data stored previously in the memory.

### SUMMARY OF THE INVENTION

It is therefore an object of the invention is to provide a rotary tray apparatus capable of determining an identification number of a disk-loading portion at a play starting position without hindrance even when a noise is superposed.

In order to achieve the object, according to a first aspect of the invention, there is provided a rotary tray apparatus in which a plurality of concave/convex portions are formed on a peripheral side wall of a rotary tray in correspondence with respective positions of a plurality of disk loading portions arranged on the rotary tray, and identification numbers of the respective disk loading portions at a play starting position is determined based on a pulse signal being output by a light receiver that receives a light emitted from a light emitter and reflected by the concave/convex portion, the apparatus including: a counter configured to count, at a predetermined intervals, a numbers of L levels and H levels in one cycle of the pulse signal, respectively; a detecting unit configured to detect whether or not a signal of an opposite level is input during the counting of respective levels; a memory configured to store previously-input counted numbers of respective levels of the pulse signals as reference values; and a controlling unit configured to determine the identification numbers based on a ratio between the numbers counted of the respective levels of the pulse signals, wherein the controlling unit is further configured to compare a counted value of a time point when the opposite level is detected with the reference values stored in the memory, and to decide that a noise signal is superposed in the pulse signal when the counted value is out of tolerances of the reference values and initialize the counted values.

According to a second aspect of the invention, there is provided a rotary tray apparatus in which a plurality of concave/convex portions are formed on a peripheral side wall of a rotary tray in correspondence with respective positions of a plurality of disk loading portions arranged on the rotary tray, and identification numbers of the respective disk loading portions at a play starting position is determined based on a pulse signal being output by a light receiver that receives a light emitted from a light emitter and reflected by the concave/convex portion, the apparatus including: a counter configured to count, at a predetermined intervals, a numbers of L levels and H levels in one cycle of the pulse signal, respectively; a detecting unit configured to detect whether or not a signal of an opposite level is input during the counting of respective levels; a memory configured to store reference values for the counted numbers of respective levels of the pulse signals; and a controlling unit configured to determine the identification numbers based on a ratio between the numbers counted of the respective levels of the pulse signals, wherein the controlling unit is further configured to compare a counted value of a time point when the opposite level is detected with the reference values stored in the memory, and to decide that a noise signal is superposed in the pulse signal when the counted value is out of tolerances of the reference values and initialize the counted values.

According to a third aspect of the invention, there is provided a method for a rotary tray apparatus in which a plurality of concave/convex portions are formed on a peripheral side wall of a rotary tray in correspondence with respective positions of a plurality of disk loading portions arranged on the rotary tray, and identification numbers of the respective disk loading portions at a play starting position is determined based on a pulse signal being output by a light receiver that receives a light emitted from a light emitter and reflected by the concave/convex portion, the method including: counting, at a predetermined intervals, a numbers of L levels and H levels in one cycle of the pulse signal, respectively; detecting whether or not a signal of an opposite level is input during the counting of respective levels; storing reference values for the counted numbers of respective levels of the pulse signals; determining the identification numbers based on a ratio between the numbers counted of the respective levels of the pulse signals; comparing a counted value of a time point when the opposite level is detected with the stored reference values; deciding that a noise signal is superposed in the pulse signal when the counted value is out of tolerances of the reference values; and initializing the counted values.

### BRIEF DESCRIPTION OF THE DRAWINGS

The above objects and advantages of the present invention will become more apparent by describing a preferred exemplary embodiment thereof in detail with reference to the accompanying drawings, wherein:

FIG. 1 is an electrical block diagram showing a schematic configuration of a rotary tray apparatus according to an embodiment of the present invention;

FIG. 2 is a perspective view showing a rotary tray of the embodiment;

FIG. 3 is a timing chart showing a case where a noise is superposed on a pulse signal; and

FIG. 4 is a flowchart showing operations of detecting a disk number.

### DETAILED DESCRIPTION OF THE PREFERRED EMBODIMENTS

Referring now to the accompanying drawings, a description will be given in detail of a preferred embodiment of the invention.

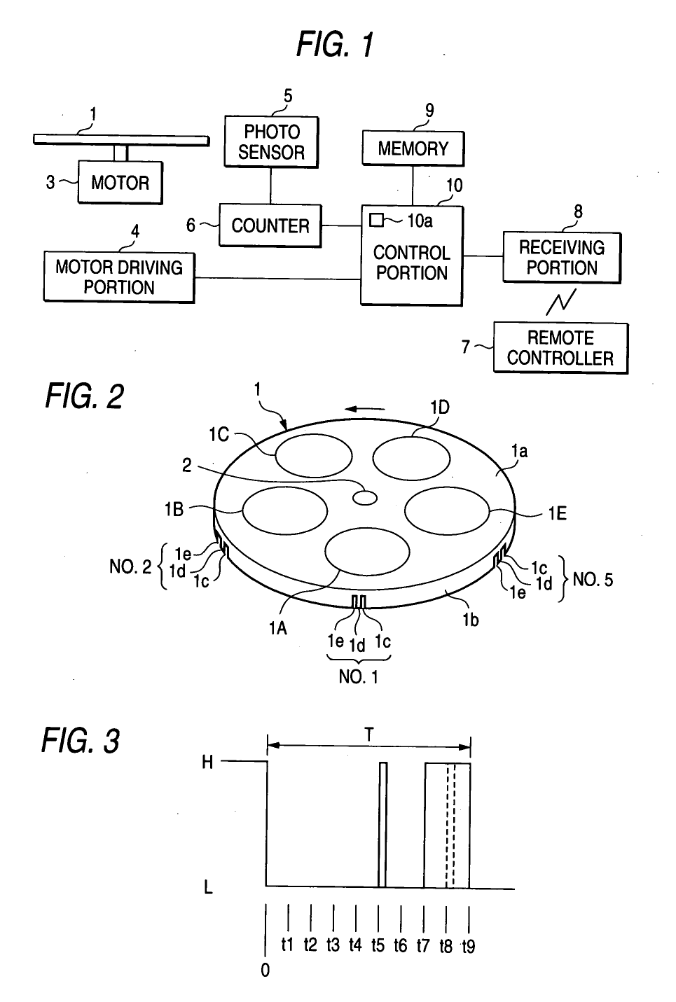

FIG. 1 is an electrical block diagram showing a schematic configuration of a rotary tray apparatus according to an embodiment of the present invention.

The rotary tray apparatus is applied to a CD player of auto-changer type that loads a plurality of CDs and selectively executes the playing (reproducing) process of each of the CD.

In FIG. 1, reference numeral 1 denotes a rotary tray, reference numeral 3 denotes a motor for rotating/driving the rotary tray 1, and reference numeral 4 denotes a motor driving portion for controlling a rotation of the motor 3.

Reference numeral 5 is a photo sensor for detecting number identifying concave/convex portions 1c to 1e of the rotary tray 1 shown in FIG. 2 to output a pulse signal to a counter 6.

The photo sensor 5, although not shown, includes a light emitting diode and a phototransistor. The light emitting diode and the phototransistor are arranged to oppose to each other in the direction that is perpendicular to a peripheral portion 1b of the rotary tray 1.

The light emitting diode is connected to a voltage output terminal, and receives a supply voltage to emit a light. The phototransistor is connected to the counter 6 via a signal converting portion that converts an input signal into the pulse signal.

When the light emitting diode emits the light during the rotation of the rotary tray 1 and then the phototransistor receives the emitted light that passes through any of the concave/convex portions 1c to 1e formed on the rotary tray 1, the photo sensor 5 outputs the pulse signal to the counter 6 in response to the contents of the received light.

As shown in FIG. 3, the counter 6, when receives the pulse signal from the photo sensor 5, counts, at a predetermined intervals (2.0 mm in the embodiment), a numbers of L levels and H levels in one cycle T of the pulse signal, respectively. The counter 6 outputs the count data to the control portion 10.

Reference numeral 7 denotes a remote controller. The remote controller 7 has a key operation portion in which used for controlling the CD player and includes a plurality of operation keys such as a power key, a play key, a stop key, a ten key, an up/down key, a disk selecting key.

When one of the operation keys is operated, the remote controller 7 transmits an infrared signal from a transmitter portion in response to the operation key that is operated. Reference numeral 8 denotes a receiving portion. The receiving portion 8, the infrared signal from the remote controller 7 is received, sends out the transmitted signal to the control portion 10.

The control portion 10 is a microcomputer for controlling operations of the overall system, and includes a noise signal detecting portion 10a in addition to a CPU, a ROM, a RAM (memory) 9, and a built-in timer.

In order to identify individual assigned numbers No. 1 through No. 5 corresponding to disk loading portions 1A through 1E, which will be described later, based on the pulse signal obtained when the concave/convex portions 1c through 1e are detected, the memory 9 stores the counted numbers of respective levels of the pulse signal, which are set in advance, as reference values.

In the embodiment, the counted numbers of respective levels of the pulse signals, which are obtained when the rotary tray 1 is rotated before the CD player is operated by the user, are used as the reference values.

In the embodiment, the noise signal detecting portion 10a causes the control portion 10 to decide whether or not the noise signal is being input, the noise signal that generated due to degradation of electronic elements or external disturbance. If the signal at the opposite level (H in the L level, L in the H level) is contained during when the counter 6 counts numbers of respective levels of the L and H levels, the noise signal detecting portion 10a transmits the data to the CPU of the control portion 10.

The control portion 10 controls respective portions of the playing system circuit in response to a command signal output from the remote controller 7 in playing to rotate/drive the rotary tray 1, then controls the rotation of the rotary tray 1 by identifying the disk number in response to the output data from the counter 6, and then executes an operation control to stop the disk loading portions 1A through 1E having the previously selected disk number on the play starting position at which a pick-up is provided.

FIG. 2 is a perspective view showing the rotary tray. The rotary tray 1 is formed in a circular disc shape. A shaft of the motor 3 is coupled to a rotary shaft 2 attached to the center of the rotary tray 1, and the rotary tray 1 is rotated/driven by the motor 3. The disk loading portions 1A through 1E on which five disks can be loaded are provided at an equal interval on the upper surface 1a side of the rotary tray 1.

Numbers 1 (No. 1) through 5 (No. 5) are assigned to each of the disk loading portions 1A through 1E along the rotating direction (direction indicated by an arrow in FIG. 2) of the rotary tray 1, respectively.

In the rotary tray 1, the concave/convex portions 1c through 1e are formed at an equal interval on the peripheral portion 1b that corresponds to a downward peripheral wall of the rotary tray 1. The concave/convex portions are used to identify the assigned numbers.

The concave/convex portions includes measurement starting point concave portions 1c provided to each of the five locations that corresponds to the disk loading portions 1A through 1E and having an equal recess width respectively, concave portions 1e having a different recess width respectively, and convex portions 1d provided between the concave portions 1c and the concave portions 1e and having a different lateral width respectively.

The measurement starting point concave portions 1c are provided as a starting point when the pulse signal is output from the photo sensor 5, and are not counted by the counter 6.

In order to identify the numbers, respective ratios of the widths are differentiated in the convex portions 1d and the concave portions 1e. The peculiar ratio is set for every assigned number of the disk when an interval from a start of the convex portion 1d to an end of the concave portions 1e is divided equally into nine parts.

In the embodiment, in order to arrange the disk loading portions 1A through 1E and the concave/convex portions 1c through 1e in an equal interval, the concave/convex portions 1c to 1e are divided equally into nine parts.

As for the identification number No. 1 that corresponds to the disk loading portion 1A, a ratio of the convex portion 1d and the concave portion 1e is set to 7:2. Subsequently, a ratio for the identification number No. 2 that corresponds to the disk loading portion 1B is set to 2:7, a ratio for the identification number No. 3 that corresponds to the disk loading portion 1C is set to 5:4, a ratio for the identification number No. 4 that corresponds to the disk loading portion ID is set to 8:1, and a ratio for the identification number No. 5 that corresponds to the disk loading portion 1E is set to 6:3.

Accordingly, all the pulse signals that are output from the photo sensor 5 when the rotary tray 1 is rotated have different lengths of the L and H levels. As a result, the control portion 10 recognizes the peculiar numbers assigned to respective concave/convex portions 1c through 1e by referring to the data being sent out from the counter 6 with the data stored in the memory 9.

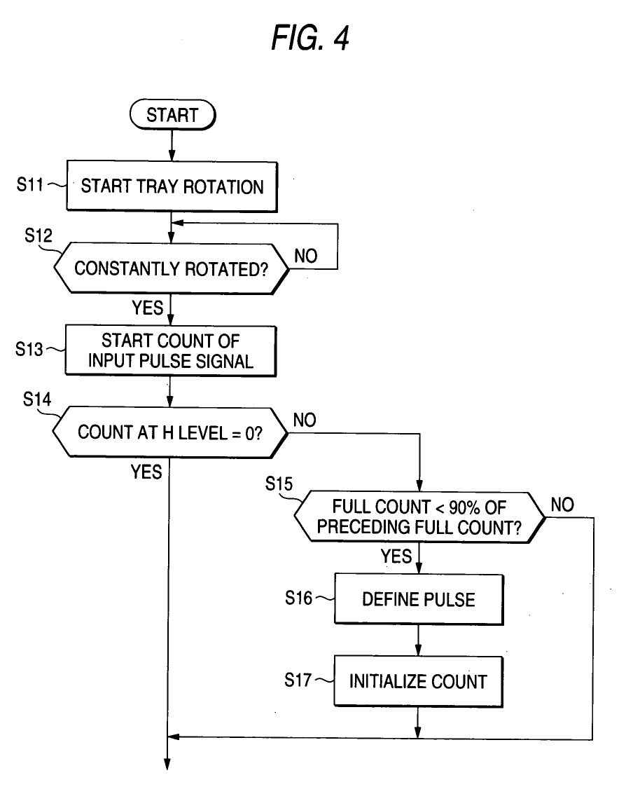

Next, operations of the above rotary tray apparatus will be explained with reference to FIG. 4 hereunder.

In the rotary tray apparatus described above, the data as the reference values are stored previously in the memory 9 while rotating the rotary tray 1 after the CD player is manufactured.

In previously storing the reference values in the memory, the rotary tray apparatus is set previously in a data storing mode, and the storing operation from a reference position is started when the rotary tray 1 is being rotated in a predetermined velocity.

When the rotary tray 1 is rotated, the pulse signals that respond to profiles of respective concave/convex portions 1c through 1e are sent out to the counter 6 from the photo sensor 5.

Then, when the counter 6 counts the numbers of L levels and H levels in one cycle T of the pulse signal, the data of the counted value is given to the control portion 10.

For example, a ratio of the convex portion 1d and the concave portion 1e is set to 7:2 in the identification number No. 1. Therefore, as shown in FIG. 3, in one cycle T of the pulse signal, the counted value of the L level is 7 and the counted value of the H level is 2.

Also, in the identification number No. 2, the counted value of the L level is 2 and the counted value of the H level is 7. When such count data are input sequentially into the control portion 10, data of respective counted values and respective numbers of No. 1 to No. 5 are stored correspondingly in addresses 1 to 5 of data areas of the memory 9.

Then, the disk number is input by the remote controller 7 and the play key is operated when the CD player is to be used.

When the control portion 10 receives the command signal, the control portion 10 starts the rotation of the rotary tray 1 (step S11), and then decides whether or not the rotary tray is being rotated in the predetermined velocity (step S12).

Then, when the rotary tray is being rotated in the predetermined velocity, the control portion 10 starts an interrupting process and causes the counter 6 to start the count of the input pulse signal (step S13).

In the input pulse signal is counted, it is decided whether or not the counted value of the H level is 0 (step S14).

For example, when a signal of the opposite level is input at a time point t5 (between t5 and t6 in FIG. 3) within the L level cycle of the input pulse signal, the noise signal detecting portion 10a decides that a signal of the H level is input in the middle of the counting of the L level, and then outputs the detected data.

At this time, since the counter 6 cannot continue the counting of the H level in one cycle T, the counted value becomes 0.

As described above, in a case where the counted value is 0, it is indicated that the noise signal is superposed on the pulse signal. Therefore, in order to avoid the false determination of the pulse signal, the control portion 10 escapes the interrupting process and enters into the counting of the succeeding input pulse signal.

On the other hand, if the counted value of the H level is not 0, the operation “Is the full count less than 90% of the preceding full count” is executed to check the full cycle of the input pulse signal (step S15).

For example, when a signal of the opposite level is input at a time point t1 (between t1 and t2 of the H level indicated by a chain line in FIG. 3) within the H level cycle of the input pulse signal, this signal is the eighth signal from the count starting. A calculation formula is 8/9=0.88 and the result is 88%.

As described above, in a case where the full count in one cycle T is less than 90% of the preceding full count, the control portion 10 decides that the noise signal is superposed on the input pulse signal.

When the noise signal is superposed on the input signal, for not affecting the determination of the pulse signal by the noise, the pulse signal is defined (step S16). Then, the counted value of the counter 6 is initialized once to discriminate the next pulse signal (step S17), and the interrupting process is continued.

On the other hand, in a case where the full count in one cycle T is equal to or more than 90% of the preceding full count, the control portion 10 decides that the noise signal is not superposed on the input pulse signal and executes the determination of the pulse signal.

As described above, in the interrupting process during the playing operation, even if the noise signal is superposed on the pulse signal, the searching of the disk number is continued by disregarding the noise signal. Therefore, such a problem can be avoided that the rotary tray 1 still continues to rotate because of the false determination caused by the noise signal and thus the selected disk number cannot be stopped quickly at the play starting position.

In the above embodiment, the counted numbers of respective levels of the pulse signals, which were input previously, are set as the reference values that are to be stored in the memory 9. However, the counted numbers peculiar to respective levels of the pulse signals may be stored as the reference values, and then the determination of the disk may be executed by using these counted numbers.

Therefore, without an influence of the unevenness in rotation caused readily when the rotary tray 1 is heavy or inversely the rotary tray 1 is light, the proper detecting of the noise signal and the proper determination of the disk number can be carried out.

Also, the intervals in counting the numbers of respective levels by the counter 6 may be changed by the control portion 10 in response to a rotation speed of the rotary tray.

As a result, such a problem can be eliminated that, since a time difference occurs in the counting in one cycle T of the pulse signal, the signal of the opposite level, when being input, cannot be detected and thus the superposition of the noise signal on the pulse signal is missed.

Also, when the rotation speed of the rotary tray 1 is considerably slower than a previously-set speed, the determination of the identification number may be stopped.

In the above configuration, even in a case such when the user touches the rotary tray 1 with the hand to stop, the false determination can be avoided by stopping the determination of the identification number.

Also, when the control portion 10 detects the noise signal at plural time on the same pulse signal at the time of determination of the identification number, it may be decided that there are defects in the number identifying concave/convex portions 1c through 1e.

As a result of such configuration, the trouble caused in the rotary tray 1 may be informed to the user and repair can be carried out immediately.

As described above, in the present invention, a counted value at the input time point is compared with the reference values in the memory when an opposite level detecting signal is sent out from the detecting unit during counting, then it is decided that a noise signal is input when the counted value is out of tolerances of the reference values, and then the counted values are initialized and determination of the identification numbers based on the input pulse signal is continued. Therefore, there can be achieved such an advantage that, even when the noise signal is superposed, the identification number of the disk loading portion at the play starting position can be discriminated without hindrance.

Also, in the present invention, a counted value at the input time point is compared with the reference values in the memory when an opposite level detecting signal is sent out from the detecting unit during counting, then it is decided that a noise signal is input when the counted value is out of tolerances of the reference values, and then the counted values are initialized and determination of the identification numbers based on the input pulse signal is continued. Therefore, there can be achieved such an advantage that, even when the noise signal is superposed, the identification number of the disk loading portion at the play starting position can be discriminated without hindrance.

Also, in the present invention, the reference values in the memory are previously-input counted numbers of respective pulse signals. Therefore, there is such an advantage that the identification number of the disk loading portion can be discriminated precisely on the basis of the state that the noise signal is not superposed.

Also, in the present invention, the controlling unit changes the counted numbers by the counter in response to a rotation speed of the rotary tray. Therefore, there is such an advantage that the problem of the false determination of the noise signal because a time difference is generated can be eliminated.

Also, in the present invention, the controlling unit stops the determination of the identification numbers when a rotation speed of the rotary tray is slower than a previously-set speed. Therefore, there is such an advantage that, when the user touches the rotary tray with the hand to stop it, etc., the false determination can be avoided.

Also, in the present invention, when the controlling unit detects the noise signal at plural time on a same pulse signal at a time of determination of the identification numbers, the controlling unit decides that there are defects in the concave/convex portions. Therefore, there is such an advantage that the trouble of the rotary tray can be informed quickly.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. A rotary tray apparatus in which a plurality of concave/convex portions are formed on a peripheral side wall of a rotary tray in correspondence with respective positions of a plurality of disk loading portions arranged on the rotary tray, and identification numbers of the respective disk loading portions at a play starting position is determined based on a pulse signal being output by a light receiver that receives a light emitted from a light emitter and reflected by the concave/convex portion, the apparatus comprising:
a counter configured to count, at a predetermined intervals, a numbers of L levels and H levels in one cycle of the pulse signal, respectively;
a detecting unit configured to detect whether or not a signal of an opposite level is input during the counting of respective levels;
a memory configured to store previously-input counted numbers of respective levels of the pulse signals as reference values; and
a controlling unit configured to determine the identification numbers based on a ratio between the numbers counted of the respective levels of the pulse signals,
wherein the controlling unit is further configured to compare a counted value of a time point when the opposite level is detected with the reference values stored in the memory, and to decide that a noise signal is superposed in the pulse signal when the counted value is out of tolerances of the reference values and initialize the counted values.

2. A rotary tray apparatus in which a plurality of concave/convex portions are formed on a peripheral side wall of a rotary tray in correspondence with respective positions of a plurality of disk loading portions arranged on the rotary tray, and identification numbers of the respective disk loading portions at a play starting position is determined based on a pulse signal being output by a light receiver that receives a light emitted from a light emitter and reflected by the concave/convex portion, the apparatus comprising:
a counter configured to count, at a predetermined intervals, a numbers of L levels and H levels in one cycle of the pulse signal, respectively;
a detecting unit configured to detect whether or not a signal of an opposite level is input during the counting of respective levels;
a memory configured to store reference values for the counted numbers of respective levels of the pulse signals; and
a controlling unit configured to determine the identification numbers based on a ratio between the numbers counted of the respective levels of the pulse signals,
wherein the controlling unit is further configured to compare a counted value of a time point when the opposite level is detected with the reference values stored in the memory, and to decide that a noise signal is superposed in the pulse signal when the counted value is out of tolerances of the reference values and initialize the counted values.

3. The rotary tray apparatus as claimed in claim 2, wherein the memory stores previously-input counted numbers of respective levels of the pulse signals as the reference values.

4. The rotary tray apparatus as claimed in claim 2, wherein the controlling unit is further configured to change the intervals in counting the numbers of respective levels by the counter in response to a rotation speed of the rotary tray.

5. The rotary tray apparatus as claimed in claim 2, wherein the controlling unit stops the determination of the identification numbers when a rotation speed of the rotary tray is slower than a predetermined speed.

6. The rotary tray apparatus as claimed in claim 2, wherein the controlling unit determines that the concave/convex portions has a defect, when a plurality of the noise signal is detected on a same pulse signal at a time of determination of the identification numbers.

7. A method for determining identification numbers in a rotary tray apparatus in which a plurality of concave/convex portions are formed on a peripheral side wall of a rotary tray in correspondence with respective positions of a plurality of disk loading portions arranged on the rotary tray, and the identification numbers of the respective disk loading portions at a play starting position is determined based on a pulse signal being output by a light receiver that receives a light emitted from a light emitter and reflected by the concave/convex portion, the method comprising:
counting, at a predetermined intervals, a numbers of L levels and H levels in one cycle of the pulse signal, respectively;
detecting whether or not a signal of an opposite level is input during the counting of respective levels;
storing reference values for the counted numbers of respective levels of the pulse signals;
determining the identification numbers based on a ratio between the numbers counted of the respective levels of the pulse signals;
comparing a counted value of a time point when the opposite level is detected with the stored reference values;
deciding that a noise signal is superposed in the pulse signal when the counted value is out of tolerances of the reference values; and
initializing the counted values.
